(19) United States
(12) Patent Application Publication
(10) Pub. No.: US 2003/0095273 A1
(43) Pub. Date: May 22, 2003

(54) Calibrating and characterising colour printers

(75) Inventor: Stephen Lawrence, New Marston (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Software 2000 Limited

(21) Appl. No.: 10/298,053

(22) Filed: Nov. 18, 2002

(30) Foreign Application Priority Data
Nov. 17, 2001 (GB) 0127613.8

(51) Int. Cl. B41J 1/00; G06F 15/00; H04N 1/46

(52) U.S. Cl. 358/1.9; 358/504

(57) ABSTRACT

A method of characterizing the colour printing characteristics of a colour printer 2 which is arranged in use to receive print commands and data from a computer system 1 coupled to the printer 2 and to print data using a first colour space (CMYK). The computer system 2 comprises an operating system for receiving print data in a second colour space (RGB) from an application residing on the computer system 1, and for passing said print data to a printer driver which converts the print data from the second colour space to the first colour space before passing the print data to the printer. The method comprises instructing the operating system to commence a printing operation using the printer 2, passing no print data or only dummy print data to the API of the operating system normally associated with the printing operation, which API expects to receive print data in the second colour space, passing print data in the first colour space to an alternative API, which API passes the print data to the printer driver, processing the print data in the printer driver and passing the data to the printer for printing, and analyzing the print output of the printer.

### FIELD OF THE INVENTION

The present invention relates to a method and computer program for calibrating and characterising colour printers.

### BACKGROUND TO THE INVENTION

Colour printers are now commonplace both in the corporate and home environments. Such printers use a subtractive colour model to create images, typically using the colours cyan C, magenta M, yellow Y, and black K, with the optional addition of other colours. For a number of reasons (including historical) computer operating systems (OSs) tend to pass colour print data to printers via an application programming interface (API) which requires the use of the red R, green G, blue B colour model which is an additive model. This results in the requirement that a printer driver (the printer “interface” software) must convert or “separate” the RGB print data received from an OS into CMYK data before it is passed to the printer. Both standardised (e.g. ICC) and proprietary conversion procedures are used.

It will be appreciated that the characteristics of colour printers will vary from printer type to printer type. For a given set of CMYK data, the print outputs of two printers may differ. These differences tend to be determined empirically, and are compensated for in the printer drivers, using colour management in the RGB to CMYK conversion. The objective of colour management is to ensure reliable colour reproduction of an “original” such that for the same RGB input data, two printer drivers which generate different CMYK data will nevertheless result in substantially identical print outputs being produced by the respective printers. This solution is advantageous because printers tend to be supplied with “matching” printer drivers which can be set up with appropriate conversion data.

A CWYK colour management table is typically generated using a profile which is a data file describing the colour behaviour of the printer in question. The profile is generated by printing testcharts (containing a set of colour swatches), inspecting the printed testcharts using some colour measurement technique, and comparing the source testcharts against the actual printed results. In view of the previous discussion, it will be appreciated that RGB testchart data must be passed to the OS. This is then passed to the printer driver where it is converted into CMYK data. This conversion results in some colour change in the data provided to the printer. Differences in the colour information contained in the source testchart and the printed output are not therefore solely attributable to the characteristics of the printer. However, there is no way to separate the effects of the printer and the colour management carried out by the driver. This will result in errors in any subsequently derived colour profile for the printer.

### SUMMARY OF THE PRESENT INVENTION

In order to create optimal profiles, the test tool should be able to print testcharts which directly control the individual output colour channels of the printer being characterised. Thus for example, the tool should be able to print CMYK testcharts when characterising a CMYK printer.

According to a first aspect of the present invention there is provided a method of characterising the colour printing characteristics of a colour printer which is arranged in use to receive print commands and data from a computer system coupled to the printer and to print data using a first colour space, the computer system comprising an operating system for receiving print data in a second colour space from an application residing on the computer system, and for passing said print data to a printer driver which converts the print data from the second colour space to the first colour space before passing the print data to the printer, the method comprising:

instructing the operating system to commence a printing operation using the printer;

passing no print data or only dummy print data to the API of the operating system normally associated with the printing operation, which API expects to receive print data in the second colour space;

passing print data in the first colour space to an alternative API, which API passes the print data to the printer driver;

processing the print data in the printer driver and passing the data to the printer for printing; and

analysing the print output of the printer.

Embodiments of the present invention effectively provide a “back door” through which print data in said first colour space may be passed from a test tool (or application) to the printer driver. No colour management operation (e.g. colour space conversion) needs to be carried out by the driver.

Preferably, said alternative API does not form part of the OS. More preferably, the alternative API is associated with a test tool which performs the steps of instructing the operating system to commence a printing operation using the printer and, if necessary, passing dummy print data to the API of the operating system normally associated with the printing operation. Upon receipt of data from the alternative API, the printer knows to ignore any data received from the normal API and responds only to the data received from the alternative API. Once all of the print data has been passed to the printer driver via the alternative API, the test tool may instruct the operating system to terminate the printing operation.

In one embodiment, said first colour space is CMYK and said second colour space is RGB. The invention may also be applied to other colour spaces.

Preferably, the print data in the first colour space passed to said alternative API corresponds to a colour testchart.

The step of processing the print data in the printer driver may comprise rasterising the data. This step may also comprise halftoning the rasterised data.

According to a second aspect of the present invention there is provided an electronic data storage medium having stored thereon a computer program for causing a computer to print a colour testchart for use in characterising the colour printing characteristics of a colour printer which is arranged in use to receive print commands and data from a computer system coupled to the printer and to print data using a first colour space, the computer system comprising an operating system for receiving print data in a second colour space from an application residing on the computer system, and for passing said print data to a printer driver which converts the print data from the second colour space to the first colour space before passing the print data to the printer, the program causing the computer to:

instruct the operating system to commence a printing operation using the printer;

pass no print data or only dummy print data to the API of the operating system normally associated with the printing operation, which API expects to receive print data in the second colour space;

pass print data in the first colour space to an alternative API, which API passes the print data to the printer driver; and

processing the print data in the printer driver and passing the data to the printer for printing.

### BRIEF DESCRIPTION OF THE DRAWINGS

FIG. 1 illustrates a typical computer system;

FIG. 2 illustrates in block diagram form objects of the computer system associated with a printer characterisation procedure; and

FIG. 3 is a flow diagram illustrating a method embodying the present invention.

### DESCRIPTION OF CERTAIN EMBODIMENTS

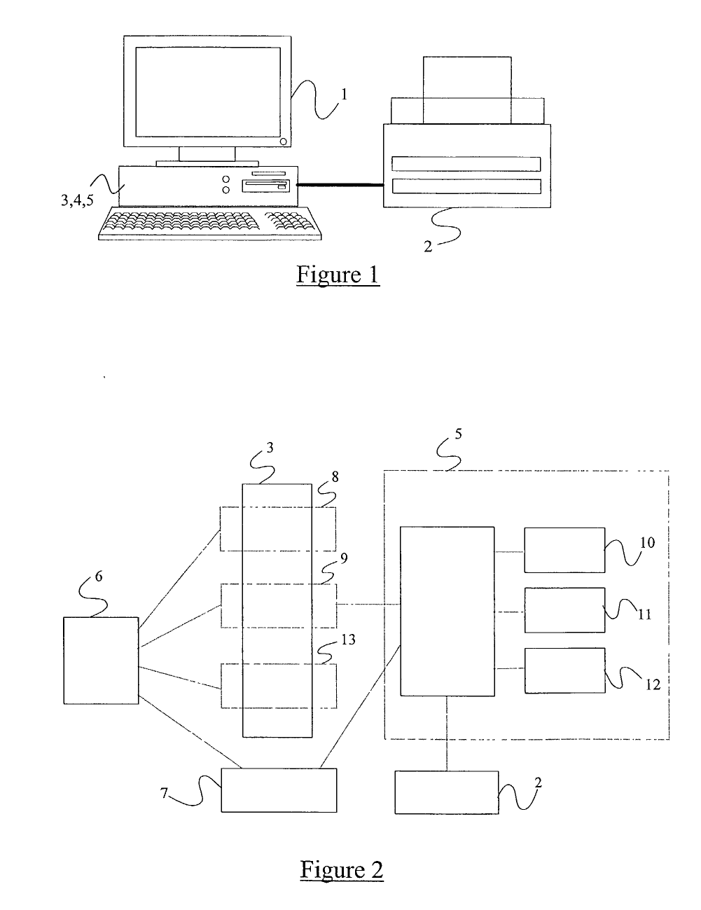

There is illustrated in FIG. 1 a personal computer (PC) 1 and a colour printer 2. The PC is controlled by a software operating system (OS) 3 such as Microsoft Windows 98™, LINUX, or UNIX™, and is arranged to run applications 4 such as Microsoft Word™, Adobe PhotoShop™ and the like. In use, data to be printed is transferred from an application 4, under the control of the operating system 3, to a software module known as a printer driver 5. Printer drivers are usually printer specific and are typically installed into a PC from a printer manufacturer's CD ROM or from a driver library provided with the operating system. Printer drivers may be updated, e.g. to add new features or to fix bugs, using executable files supplied by the driver manufacturers.

As explained above, a printer driver should incorporate and make use of a profile for the associated printer in order to optimise the print output of the printer. A mechanism for generating such a profile will now be explained with reference to FIG. 2. It will be appreciated that this mechanism is used once to generate a suitable profile, and that that profile can be incorporated into all printer drivers for designed for the printer which is tested.

A test tool software application 6 is loaded into the PC 1. This installs an application programming interface API 7 into the PC 1 which is in addition to other APIs, e.g. associated with the OS 3. This API 7 provides a backdoor linking the test tool 6 to the printer driver 5. The test tool has access to at least one data file which defines colour test chart using the CMYK colour model. The structure of the test tool and the new API will be readily apparent from the following discussion of their operation.

When a user opens the test tool and selects a print testchart option, the test tool passes relevant information to the appropriate API 8 of the OS 3. In the case of a Windows 98 this API is the StartDoc API, and the OS will respond by starting a print job to enable the test tool to print. The test tool application will print the testchart document by passing the data to be printed to the drawing APIs 9 of the OS. The draw commands will consist of text commands to annotate the testchart on the printed page and image commands to draw the testchart itself. The test tool 6 writes dummy data to the image draw APIs 9. At the same time, the test tool 6 writes the actual data to be printed, i.e. the CMYK test chart, to the alternative API 7. This API 7 passes the print data directly to the printer driver 5. The CMYK data does not pass through the operating system.

The printer driver 5 is configured such that when it receives print data from the API 7, it ignores any print data received from the OS API 9. The printer driver 5 also knows that print data received from the API 7 does not require conversion from RGB to CMYK (including colour management). The CMYK data is first passed to a rasterisation module 10 of the printer driver. The rasterised data is then passed to a rendering module 11. A main function of the rendering module 11 is to convert the pixel intensity data into corresponding halftone values (most printers are incapable of varying the intensity of a printed pixel, and so intensity variations are achieved by mixing colour and white pixels to an appropriate degree, a process known as “halftoning”). The halftone data is then passed to a formatting module 12 which arranges the data, and introduces formatting commands, into a form acceptable to the printer 2. The processed print data is passed by the printer driver 5 to the printer 2 as it is processed, or is placed in a print queue if necessary.

When this process is complete (or earlier if print data received from the API 7 is buffered by the printer driver 5), the test tool 6 terminates the printing process by writing to the appropriate API of the OS 3 (e.g. the EndDoc API of the Windows 98 OS). As far as the OS is concerned, the printer has printed the RGB data received by the API 9. The OS 3 is unaware that alternative CMYK data has been passed via a back door to the printer driver 5.

Once the testchart has been printed, the colours contained in the printed output are inspected, typically using some colour measurement instrument. The results are compared to the values contained in the data file associated with the test tool 6. Based upon this comparison an appropriate profile is constructed. This profile is incorporated into printer drivers for printers of the same type.

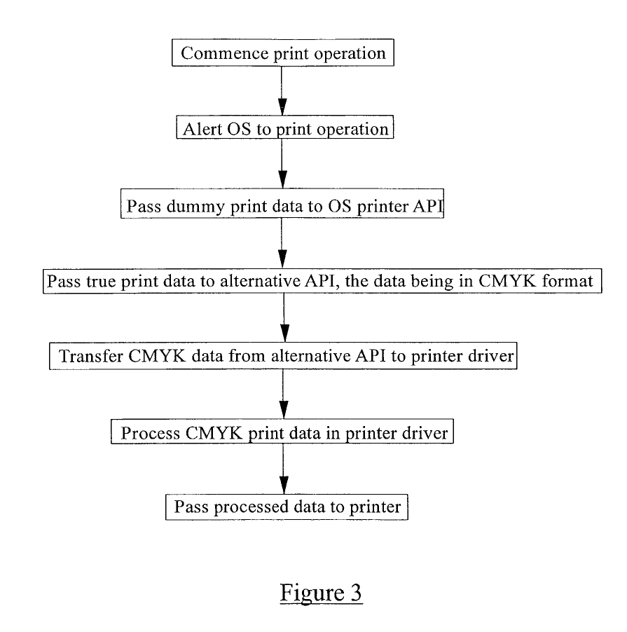

The method described above is further illustrated in the flow diagram of FIG. 3.

It will be appreciated by the person of skill in the art that various modifications may be made to the above described embodiments without departing from the scope of the present invention. For example, rather than CMYK, said the first colour space may be CMYKOG (cyan, magenta, yellow, black, orange, green) or indeed variations of this colour space.

1. A method of calibrating and/or characterising the colour printing characteristics of a colour printer which is arranged in use to receive print commands and data from a computer system coupled to the printer and to print data using a first colour space, the computer system comprising an operating system for receiving print data in a second colour space from an application residing on the computer system, and for passing said print data to a printer driver which converts the print data from the second colour space to the first colour space before passing the print data to the printer, the method comprising:
instructing the operating system to commence a printing operation using the printer;
passing no print data or only dummy print data to the API of the operating system normally associated with the printing operation, which API expects to receive print data in the second colour space;
passing print data in the first colour space to an alternative API, which API passes the print data to the printer driver;
processing the print data in the printer driver and passing the data to the printer for printing; and
analysing the print output of the printer.

2. A method according to claim 1, wherein said alternative API does not form part of the OS.

3. A method according to claim 1, wherein the alternative API is associated with a test tool which performs the steps of instructing the operating system to commence a printing operation using the printer and, if necessary, passing dummy print data to the API of the operating system normally associated with the printing operation.

4. A method according to claim 3, wherein upon receipt of data from the alternative API, the printer driver knows to ignore any data received from the normal API and responds only to the data received from the alternative API. Once all of the print data has been passed to the printer driver via the alternative API, the test tool may instruct the operating system to terminate the printing operation.

5. A method according to claim 1, wherein said first colour space is CMYK and said second colour space is RGB.

6. A method according to claim 1, wherein the print data in the first colour space passed to said alternative API corresponds to a colour testchart.

7. A method according to claim 1, wherein the step of processing the print data in the printer driver comprises rasterising the data and halftoning the rasterised data.

8. An electronic data storage medium having stored thereon a computer program for causing a computer to print a colour testchart for use in characterising the colour printing characteristics of a colour printer which is arranged in use to receive print commands and data from a computer system coupled to the printer and to print data using a first colour space, the computer system comprising an operating system for receiving print data in a second colour space from an application residing on the computer system, and for passing said print data to a printer driver which converts the print data from the second colour space to the first colour space before passing the print data to the printer, the program causing the computer to:
instruct the operating system to commence a printing operation using the printer;
pass no print data or only dummy print data to the API of the operating system normally associated with the printing operation, which API expects to receive print data in the second colour space;
pass print data in the first colour space to an alternative API, which API passes the print data to the printer driver; and
processing the print data in the printer driver and passing the data to the printer for printing.
